(19) United States
(12) Patent Application Publication
(10) Pub. No.: US 2019/0186695 A1
(43) Pub. Date: Jun. 20, 2019

(54) VALVE AND PRESSURIZED FLUID CYLINDER

(71) Applicant: L'Air Liquide, Société Anonyme pour l'Etude et l'Exploitation des Procédés Georges Claude, Paris (FR)

(72) Inventors: Aurélien Ferre, Antony (FR); Philippe Rudnianyn, Antony (FR); Celestin Batut, Antony (FR)

(21) Appl. No.: 16/212,128

(22) Filed: Dec. 6, 2018

(30) Foreign Application Priority Data
Dec. 19, 2017 (FR) 1762413

(51) Int. Cl. F17C 13/04; F16K 17/02; F16K 7/12

(52) U.S. Cl. CPC F17C 13/04; F16L 37/00; F16K 7/12; F16K 17/02

(57) ABSTRACT

Valve comprising a body accommodating a withdrawing circuit comprising a first, upstream end and a second, downstream end intended to be connected to a consumer of the withdrawn gas, the withdrawing circuit comprising a member for regulating the fluid flow rate and/or pressure, the valve comprising a sensor for sensing the position of the control member, said sensor being configured to generate an electric signal indicative of the position of the latter or of the fluid flow rate and/or pressure set by the regulating member, the position sensor comprising at least one detectable element situated on the body of the valve or, respectively, on the control member and at least one measuring element situated on the control member or, respectively, on the body of the valve, at least one of the at least one detectable element and the at least one measuring element being covered with or enclosed in a protective membrane.

### CROSS REFERENCE TO RELATED APPLICATIONS

This application claims the benefit of priority under 35 U.S.C. § 119 (a) and (b) to French Patent Application No. 1762413, filed Dec. 19, 2017, the entire contents of which are incorporated herein by reference.

### BACKGROUND

The invention relates to a valve for a pressurized fluid cylinder and to a corresponding cylinder.

The invention relates more particularly to a valve for a pressurized fluid cylinder, comprising a body provided with an end intended to be connected to the orifice of a pressurized fluid cylinder, the body of the valve accommodating a withdrawing circuit comprising a first, upstream end intended to communicate with the storage volume of a pressurized fluid cylinder and a second, downstream end intended to be connected to a consumer of the withdrawn gas, the withdrawing circuit comprising a member for regulating the flow rate and/or the pressure of the withdrawn fluid between the upstream end and downstream end, the valve comprising a member for manually controlling the regulating member, the control member being mounted so as to be able to move relative to the body of the valve and cooperating with the regulating member to control the flow rate and/or the pressure of fluid allowed to circulate from the upstream end to the downstream end depending on the position of the control member with respect to the body of the valve, the valve comprising a sensor for sensing the position of the control member, said sensor being configured to generate an electric signal indicative of the position of the latter or of the fluid flow rate and/or pressure set by the regulating member, the position sensor comprising at least one detectable element situated on the body of the valve or, respectively, on the control member, and at least one measuring element situated on the control member or, respectively, on the body of the valve.

The invention relates to a valve provided with an electronic device for indicating physical data relating to the content notably of pressurized gas in a pressurized fluid cylinder.

Reference may be made for example to the document WO2015110717A1, which describes an example of such a device. That document describes a valve provided with a detector for detecting the position of the flow-rate selector. This makes it possible to more rapidly display and/or calculate the instantaneous consumption of gas, the quantity of gas remaining in the cylinder, and the gas autonomy until the cylinder is empty.

This solution makes it possible to reliably detect the position of the selector. However, this detector structure has drawbacks including: a relatively large size, a relatively high number of parts (gear etc.), leaktightness that is difficult to realize (with respect to sand or dust in particular), difficult management of the axial and radial clearances, etc.

That document describes further embodiments of the position sensor that use one or more detectable movable elements and one or more fixed detection elements (sensors). The precision and reliability of the measurement can also be impaired given that the position sensor can be subjected to wear, dust, humidity conditions etc.

### SUMMARY

An aim of the present invention is to remedy all or some of the drawbacks of the prior art that are set out above.

To this end, the valve according to the invention, which is otherwise in accordance with the generic definition given in the preamble above, is essentially characterized in that at least one of the at least one detectable element and the at least one measuring element is covered with or enclosed in a protective membrane.

Furthermore, embodiments of the invention can include one or more of the following features:

the protective membrane is flexible or rigid,

the protective membrane is leaktight,

the membrane is made of at least one material from among: plastic, in particular polyester, an organic material, rubber, a resin,

the membrane has a thickness of between 0.1 mm and 10 mm, preferably between 0.1 and 2 mm,

the membrane has at least one orifice,

at least one of the detectable element(s) and the measuring element(s) is/are secured to or integrated in a support, the support likewise being covered with or enclosed in the protective membrane,

the valve comprises a member for acquiring, storing and processing data, and the position sensor is connected to the latter in order to transmit a signal indicative of the position of the regulating member and/or of the fluid flow rate and/or pressure set by the regulating member,

the valve comprises at least one data display and/or a data emitter connected to the member for acquiring, storing and processing data,

the at least one detectable element comprises at least one of an electric circuit comprising an electrical conductor track, a plurality of conductor tracks and one or more magnets,

the at least one measuring element comprises at least one member for measuring a magnetic field and/or an electrical resistance, and/or an electric voltage, and/or a pressure and/or a displacement and/or a light signal,

the position sensor generates a signal of given voltage and/or resistance value depending on the position of the control member with respect to the body of the valve,

the position sensor forms a potentiometer,

the member for manually controlling the regulating member is movable into a position known as the “closed” position corresponding to closure of the first withdrawing circuit, that is to say that the flow rate of fluid allowed to pass from the upstream end to the downstream end is zero,

the member for acquiring, storing and processing data is configured to cause an information item relating to the fluid flow rate and/or pressure set by the regulating member and/or to the mode of use of the valve to be displayed on the display, or, respectively, to be sent via the data emitter, in response to the reception of the signal transmitted by the position sensor.

The invention also relates to a pressurized fluid cylinder comprising a valve according to any one of the above or following features.

The invention can also relate to any alternative device or method comprising any combination of the above or following features.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 shows a schematic and partial side view illustrating a valve mounted on a pressurized gas cylinder according to one possible exemplary embodiment of the invention,

FIG. 2 schematically and partially illustrates the structure and operation of a part of the valve from FIG. 1,

FIG. 3 shows a schematic and partial front view illustrating one possible example of the structure of a part of the position sensor integrated into the valve or into a control member of a valve,

FIG. 4 shows a schematic and partial cross-sectional view illustrating a detail of the position sensor cooperating with the control member according to one possible embodiment.

### DETAILED DESCRIPTION OF PREFERRED EMBODIMENTS

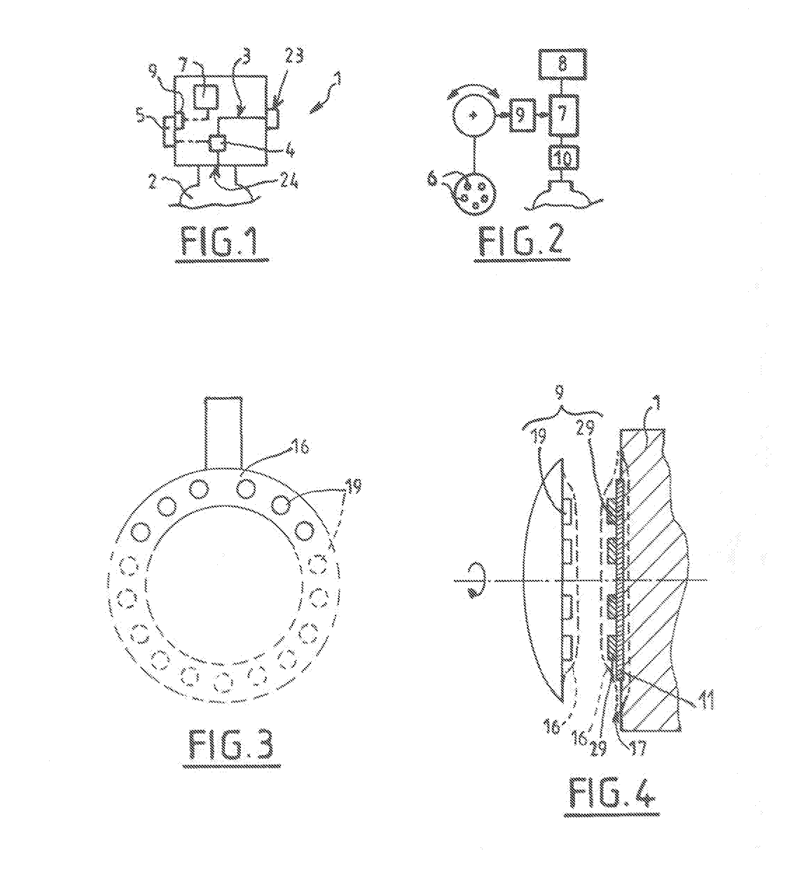

FIG. 1 schematically shows a pressurized gas cylinder 2 provided with a valve 1 that is able to implement the invention.

The valve 1 comprises a body provided with an end intended to be mounted in the orifice of a pressurized fluid cylinder 2 (for example by screwing). Alternatively, the valve 1 can be connected, via a circuit, to a set of cylinder(s).

In a conventional manner, the body of the valve 1 accommodates a withdrawing circuit 3 comprising a first, upstream end 24 communicating with the storage volume of the cylinder 2. The withdrawing circuit 3 comprises a second, downstream end 23 intended to be connected to a consumer of the withdrawn gas (for example a patient in the case of oxygen or some other medical gas).

The withdrawing circuit 3 comprises a member 4 for regulating the flow rate and/or the pressure of the withdrawn fluid between the upstream end 24 and downstream end 23. This regulating member 4 is for example a flow rate regulator having calibrated orifices 6, making it possible to select a withdrawn gas flow rate (cf. the schematic depiction in FIG. 2). Of course, any other regulating member is conceivable, for example a valve with a proportional opening.

The valve 1 comprises a member 5 for manually controlling the regulating member 4. The control member 5 is mounted so as to be able to move relative to the body of the valve 1 and cooperates with the regulating member 4 to control the flow rate and/or pressure of fluid allowed to circulate depending on the position of the control member 5 with respect to the body of the valve 1.

The control member 5 comprises for example a rotary hand wheel (cf. FIG. 4). Of course, any other appropriate system is conceivable (pivoting lever, etc.). For example, the control member 5 selects a calibrated orifice 6 and/or controls a flow rate restriction valve depending on its position among a plurality of separate (preferably stable) positions or a plurality of positions of a continuous movement. In particular, the stable positions can be mechanically referenced by a hard point (for example via a detent system in particular).

The valve 1 comprises an electronic device for indicating data relating to the content of fluid in a cylinder 2 connected to the valve 1. The device can be of the type comprising a member 7 for acquiring, storing and processing data and at least one data display 8 connected to the member 7 for acquiring, storing and processing data (cf. FIGS. 1 and 2).

The member 7 for acquiring, storing and processing data comprises for example a calculator and/or computer and/or a microprocessor or any other equivalent system.

Of course, this device can have one or more data receiving members (via a wired and/or wireless connection: antenna(s), port(s) etc.) and also one or more data output members (via a wired and/or wireless connection: antenna(s), port(s)).

The valve 1 has a sensor 9 for sensing the position of the member 5 for manually controlling the regulating member 4. The position sensor 9 is connected to the member 7 for acquiring, storing and processing data in order to transmit to the latter a signal indicative of the position of the control member 5 or directly a signal corresponding to the fluid flow rate and/or pressure set by the regulating member 4.

The sensor 9 for sensing the position of the control member 5 comprises for example a converter for converting the mechanical movement of the control member 5 into an electrical signal that is exploitable by the member 7 for acquiring, storing and processing data.

The position sensor 9 supplies for example an electrical or digital signal determined depending on the position of the control member 5. This signal can be supplied in a wired and/or wireless manner.

The position sensor comprises at least one detectable element 19 situated on the body of the valve 1 (fixed) or, respectively, on the control member 5 (movable).

The position sensor 9 also comprises at least one measuring element 29 of the detectable element that is situated on the control member 5 (movable) or, respectively, on the body of the valve 1 (fixed).

The measuring element(s) 29 can comprise any member for measuring an electric signal (voltage, current, magnetic field, resistance, light signal etc.) or for measuring a mechanical parameter. The detectable element(s) 19 can comprise any matching member (conductor track, magnet(s), geometric discontinuity, colour etc.). Reference may be made for example to the document WO16162625A1.

At least a part of the detectable element 19 and/or of the measuring element 29 is/are covered with or enclosed in a protective membrane 16. In the example in FIG. 4, the detectable elements 19 (conductor tracks and/or magnets or the like) are accommodated in a protective membrane 16 and the measuring elements 29 are likewise disposed in a respective protective membrane. Alternatively, only one of the assemblies (19 or 29) could be accommodated in a membrane 16.

The protective membrane 16 can be flexible or rigid. Preferably, this membrane 16 is leaktight. The membrane 16 can be made of at least one material from among: plastic, in particular polyester, organic material, rubber, resin, etc. The membrane 16, which can be transparent, can have a thickness of between 0.01 mm and 10 mm, preferably between 0.1 and 2 mm.

In particular in the case of a leaktight membrane 16, the membrane 16 can have at least one orifice 17. The orifice 17, which can be situated at one end, can be provided to regulate the pressure within the membrane (in the case of variation in pressure and/or temperature). The orifice can in particular be advantageous in the case of contact and/or relative deformation between the detectable element 19 and the measuring element 29.

The detectable element 19 and/or the measuring element 29 can be fixed to or integrated in a support 11, for example a plate. The support 11 is preferably likewise covered with or enclosed in the protective membrane 16 or secured to this membrane 16.

As illustrated in FIG. 3, the detectable elements 19 can be distributed in a circle or circular arc in a spaced-apart manner. These detectable elements 19 can cooperate with one or more measuring elements 29.

The relative position of the elements 19 placed on the rotary control member with respect to the measuring element(s) 29 positioned on the valve makes it possible to determine the position of the control member 5.

This detection can be based on a binary code. Thus, it is the combination of detection of the elements 19 positioned on the control member 5 which will make it possible to know the position thereof (for example from 12 different positions/configurations).

As indicated above, various technologies can be envisaged for the detectable elements 19 and measuring elements 29:

detection by contact (the elements 19 placed on the movable control member 5 can be bosses which will make contact with push buttons 29),

magnetic detection (the detectable elements 19 placed on the control member 5 can be magnets which will be detected by virtue of their magnetic field by magnetic sensors 29),

capacitive detection via one or more capacitive sensors which contactlessly detect(s) one or more electric field(s).

The elements (19 and/or 29) are incorporated in a protective membrane 16. This membrane 16 makes it possible to protect the solution of detection preferably in a sealed manner with respect to the outside environment.

The inclusion of these elements 19 and/or 29 of the sensor 9 in a protective membrane makes it possible to improve the reliability and the reproducibility of the detection of the position of the control member 5. This also makes it possible to increase the service life of the device over time.

In particular, the use of one (or two) membrane(s) does not hamper the quality of detection; quite the contrary. Even in the event of soiling (in particular between a detectable element 19 and a measuring element 29), the detection of the position is not impaired.

The invention also applies to other forms of position sensor 9. For example, the detectable element 19 can be made up of one or more continuous conductor tracks that have a given electrical resistance and cooperate with a detection element 29 which measures a variable characteristic (resistance/voltage). In other words, the relative movement of the elements 19, 29 changes the electrical signature (voltage and/or resistance measured by a measuring member) in the manner of a potentiometer.

For example, an electrical contact which delimits the length of a conductor track is realized inside the membrane 16 via a wiper which bears on the membrane 16. The wiper is for example secured to the movable control member 5 and the track is secured to the fixed part of the valve 1.

The wiper can elastically deform the former locally in order to form localized electrical contact with the conductive circuit or conductor track.

The two elements (movable 19 and fixed 29) of the sensor 9 are thus preferably separated, allowing them not to touch when at rest and therefore not to conduct a current (open circuit). This can be exploited in at least one position of the control member 5.

As illustrated schematically in FIG. 2, the valve 1 can also have a pressure sensor 10 intended to measure the pressure within the storage volume of the cylinder 2. The pressure sensor 10 can be connected to the member 7 for acquiring, storing and processing data in order to transmit to the latter a signal indicative of the measured fluid pressure. The member 7 for acquiring, storing and processing data can be configured to calculate and display on the display 8 an information item relating to the autonomy or content of fluid remaining in the cylinder 2 in response to the reception of this pressure signal (also on the basis preferably of the information given by the sensor 9 for sensing the position of the control member 5 which determines the flow rate withdrawn from the cylinder 2).

For example, the information relating to the autonomy or content of fluid remaining in the cylinder 2 can be expressed in time remaining (or, respectively, in quantity remaining) by dividing the initial pressure measured by the pressure sensor 10 (or, respectively, a quantity of gas flowing) by the theoretical variation in pressure set by the regulating member 4 (or, respectively, the variation in quantity set by the regulating member (4)), by a formula for example of the type: Time remaining=lnitial pressure/variation in pressure set (or, respectively: Time remaining=Remaining fluid content/variation in quantity set).

The theoretical variations in quantity or pressure can be calculated for example via the perfect gas equation PV=nRT or real gas equation PV=ZnRT (S.I. units).

The volume V of the cylinder 2 can be known and entered in the member 7 for acquiring, storing and processing data and the temperature can be measured by an exterior ambient sensor or calculated or entered or approximated.

The position sensor 9 system has the advantage of reliable detection without being bulky. The sensor and the protective membrane 16 can be integrated into a cramped volume.

At least one of the position sensor 9 and the pressure sensor 10, the display 8, the member 7 for acquiring, storing and processing data can be powered electrically by a battery and/or an inductive system.

Preferably, the member 5 for manually controlling the regulating member 4 can be moved into a position known as the “closed” position corresponding to closure of the withdrawing circuit 3. In other words, the flow rate of fluid allowed to pass from the upstream end 13 to the downstream end 23 is zero.

Preferably, in the closed position of the control member 5, the position sensor 9 consumes no energy.

Although not shown for the sake of simplification, the valve 1 can comprise another filling and/or withdrawing circuit, for example separate from the withdrawing circuit 3. If need be, this second filling circuit can have a portion in common with the withdrawing circuit 3.

The invention applies advantageously to pressurized gas cylinders, notably cylinders containing pressurized oxygen.

The solution can relate in particular to rotary flow rate selectors that can be located on the valve (for example with a relief valve) of a pressurized cylinder. More particularly, the solution proposes a detection system that makes it possible to know the flow rate selected by the user by virtue of the detected position of the rotary element.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A valve for a pressurized fluid cylinder, comprising a body provided with an end configured to connect to an orifice of a pressurized fluid cylinder, the body of the valve (1) accommodating a withdrawing circuit (3) comprising a first, upstream end (24) intended to communicate with the storage volume of a pressurized fluid cylinder and a second, downstream end (23) configured to connect to a consumer of the withdrawn gas, the withdrawing circuit (3) comprising a member (4) for regulating the flow rate and/or the pressure of the withdrawn fluid between the upstream end (24) and downstream end (23), the valve (1) comprising a member (5) for manually controlling the regulating member (4), the control member (5) being able to move relative to the body of the valve (1) and cooperating with the regulating member (4) to control the flow rate and/or the pressure of fluid allowed to circulate from the upstream end (24) to the downstream end (23) depending on the position of the control member (5) with respect to the body of the valve (1), the valve (1) comprising a sensor (9) for sensing the position of the control member (5), said sensor (9) being configured to generate an electric signal indicative of the position of the latter or of the fluid flow rate and/or pressure set by the regulating member (4), the position sensor comprising at least one detectable element (19) situated on the body of the valve (1) or, respectively, on the control member (5), and at least one measuring element (29) situated on the control member (5) or, respectively, on the body of the valve (1), wherein at least one of the at least one detectable element (19) and the at least one measuring element (29) is covered with or enclosed in a protective membrane (16).

2. The valve according to claim 1, wherein the protective membrane (16) is flexible or rigid.

3. The valve according to claim 1, wherein the protective membrane (16) is leaktight.

4. The valve according to claim 1, wherein the membrane (16) is made of at least one material from among: plastic, in particular polyester, an organic material, rubber, a resin.

5. The valve according to claim 1, wherein the membrane (16) has a thickness of between 0.1 mm and 10 mm.

6. The valve according claim 1, wherein the membrane (16) has at least one orifice (17).

7. The valve according to claim 1, wherein at least one of the detectable element(s) (19) and the measuring element(s) (29) is/are secured to or integrated in a support (11), and in that the support is likewise covered with or enclosed in the protective membrane (16).

8. The valve according to claim 1, further comprising a member (7) for acquiring, storing and processing data, and in that the position sensor (9) is connected to the latter in order to transmit a signal indicative of the position of the regulating member (5) and/or of the fluid flow rate and/or pressure set by the regulating member (5).

9. The valve according to claim 8, further comprising at least one data display (8) and/or a data emitter connected to the member (7) for acquiring, storing and processing data.

10. A pressurized fluid cylinder, comprising a valve according to claim 1.
